(19) United States
(12) Patent Application Publication
(10) Pub. No.: US 2025/0111807 A1
(43) Pub. Date: Apr. 3, 2025

(54) HIGH REFLECTIVITY COATINGS DEPOSITED VIA PHYSICAL VAPOR DEPOSITION

(71) Applicant: CORNING INCORPORATED, CORNING, NY (US)

(72) Inventor: Xu Ouyang, Painted Post, NY (US)

(21) Appl. No.: 18/896,351

(22) Filed: Sep. 25, 2024

Related U.S. Application Data
(60) Provisional application No. 63/541,996, filed on Oct. 2, 2023.

(51) Int. Cl. G09F 13/16; G02B 5/28

(52) U.S. Cl. CPC G09F 13/16; G02B 5/285

(57) ABSTRACT

A structure includes a substrate formed of glass, plastic, or a combination thereof, the substrate comprising a first surface and a second surface opposite the first surface. The structure also includes a layered film disposed on the first surface of the substrate. The layered film includes a reflectivity-control layer including chromium, aluminum, silver, or Inconel. When viewed from the second surface, a region of the structure including the layered film exhibits a neutral gray color and a reflectivity of about 4% to about 98% when light is initially incident on the second surface and reflects off of the layered film. The layered film is patterned such that a peripheral shape of the layered film defining the region differs from a peripheral shape of the substrate.

### CROSS-REFERENCE TO RELATED APPLICATIONS

This application claims the benefit of priority of U.S. Application Ser. No. 63/541,996, filed on Oct. 2, 2023, the content of which is relied upon and incorporated herein by reference in its entirety.

### TECHNICAL FIELD

The present application is generally related to the field of thin-film coatings, and more specifically is related to thin-film coatings with controlled reflectivity properties.

### BACKGROUND

Images or patterns are added to transparent glass or plastic for many reasons, such as for use as a logo that distinguishes one product or brand from another, to indicate the location of touch buttons, to indicate the status of a device, or to cover lenses to mask electronic components in consumer electronic devices. Conventional methods to create patterns, logos, or images on transparent or semi-transparent glass or plastic include offset lithography, flexography, digital printing (e.g., Inkjet printing), gravure, screen printing, spray deposition with masking tapes, and pressure printing. However, using these methods typically results in images, patterns, or logos with imprecise and uneven edges, resulting in substandard print quality. Physical vapor deposition (PVD) and chemical vapor deposition (CVD) may provide more precise and even edges, but are typically limited in terms of their optical qualities. For example, PVD and CVD methods are typically limited in terms of the reflectivity, transmissivity, and color appearance of the resulting coating.

### SUMMARY

In one embodiment, a structure includes a substrate formed of glass, plastic, or a combination thereof. The substrate includes a first surface and a second surface opposite the first surface. The structure also includes a layered film disposed on the first surface of the substrate. The layered film includes a reflectivity-control layer including chromium, aluminum, silver, or Inconel. When viewed from the second surface, a region of the structure including the layered film exhibits a neutral gray color and a reflectivity of about 4% to about 98% when light is initially incident on the second surface and reflects off of the layered film. The layered film is patterned such that a peripheral shape of the layered film defining the region differs from a peripheral shape of the substrate.

The layered film may exhibit a*/b* less than 1. In a wavelength range of 400 nm to 700 nm, a reflectance of the layered film may increase by no more than 5% when an angle of incidence of the light on the layered film increases from 6° to 50°. The reflectivity-control layer may include chromium and have a thickness of about 3 nm to about 50 nm. The layered film may further include a color control stack including two low-index layers having a refractive index (n) less than 1.7 and a high-index layer between the two low-index layers having n greater than 1.7. The color control stack may be disposed between the first surface of the substrate and the reflectivity-control layer. The two low-index layers may include SiO₂, Al₂O₃, or a combination thereof. The high-index layer may include Nb₂O₅, TiO₂, ZrO₂, HfO₂, Ta₂O₅, ZnO, SnO₂, or a combination of two or more thereof. The coating may further include a light blocking stack including a light absorbing layer and a light blocking layer, the light blocking layer providing an optical density of greater than 4. The light absorbing layer may be CrOₓ, wherein x is in the range of 1 to 5. The light blocking layer may be chromium metal having a thickness of at least 120 nm. The thickness of the layered film may be about 100 nm to about 300 nm. The substrate may have a reflectivity of about 3% to about 10%. The peripheral shape of the layered film may include a pattern, logo, or image. The structure may further include an ink layer disposed on a second surface of the substrate or on a portion of the layered film. The structure may include an illumination source providing light directed toward the second surface. The ink layer may exhibit a reflected color from the illumination source with a AE value that is less than or equal to 5.0 as compared to the region of the structure including the layered film.

In another embodiment, a method of manufacturing a structure is disclosed. The method includes depositing a layered film on a first surface of a substrate via physical vapor deposition (PVD). The method also includes patterning the layered film such that a peripheral shape of the layered film defining a region including the layered film is different from a peripheral shape of the substrate. When viewed from a second surface of the substrate opposite the first surface, the region including the layered film exhibits a neutral gray color and a reflectivity of about 4% to about 98% when light is initially incident on the second surface and reflects off of the layered film.

Depositing the layered film may include depositing a reflectivity-control layer including chromium, aluminum, silver, or Inconel on the first surface; depositing a light absorbing layer on the reflectivity-control layer; and depositing a light blocking layer on the light absorbing layer, the light blocking layer providing an optical density greater than 4. The reflectivity-control layer may have a thickness of about 3 nm to about 50 nm. The light absorbing layer may be CrOₓ, wherein x is in the range of 1 to 5. The light blocking layer may be chromium metal having a thickness of at least 120 nm. Depositing the layered film may further include depositing a first low-index layer having a refractive index (n) less than 1.7 onto the first surface; depositing a high-index layer having n greater than 1.7 onto the first low-index layer; and depositing a second low-index layer having a refractive index (n) less than 1.7 onto the high-index layer. The first low-index layer and the second low-index layer may each include SiO₂, Al₂O₃, or a combination thereof. The high-index layer may include Nb₂O₅, TiO₂, ZrO₂, HfO₂, Ta₂O₅, ZnO, SnO₂, or a combination of two or more thereof. The peripheral shape of the layered film comprises a pattern, a logo, or an image. The method may further include disposing an ink layer on a second surface of the substrate or on a portion of the layered film. The method may further include providing light directed toward the second surface.

In another embodiment, a layered film is disclosed. The layered film includes a first layer comprising SiO₂ having a thickness of about 15 nm to about 90 nm; a second layer disposed on the first layer, the second layer comprising Nb₂O₅ having a thickness of about 5 nm to about 20 nm; a third layer disposed on the second layer, the third layer comprising SiO₂ having a thickness of about 20 nm to about 50 nm; a fourth layer disposed on the third layer, the fourth layer comprising chromium metal having a thickness of about 3 nm to about 50 nm; a fifth layer disposed on the fourth layer, the fifth layer comprising CrOₓ, wherein x is in a range of 1 to 5, the fifth layer having a thickness of about 10 nm to about 80 nm; and a sixth layer disposed on the fifth layer, the sixth layer comprising chromium metal having a thickness of about 110 nm to about 130 nm.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is an illustration of a coated structure, according to an example embodiment.

FIG. 2 is an example flow diagram of a process for depositing a layered film on a substrate, according to an example embodiment.

FIG. 3 is a graph of the reflectivity of example coated structures, according to an example embodiment.

FIG. 4 is another graph of the reflectivity of example coated structures, according to an example embodiment.

FIG. 5 is a graph of reflectivity of an example layered film at different angles of incidence, according to an example embodiment.

FIG. 6 is an illustration of the color change of an example coating with changing angle of incidence, according to an example embodiment.

FIG. 7 is a photograph of two example coatings on glass, according to an example embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better explain the embodiments and does not pose a limitation on the scope of the claims unless otherwise stated. No language in the specification should be construed as indicating any non-claimed element as essential.

As used herein, “neutral gray” is a gray color of a material having a reflectance at red (700 nm), blue (450 nm), and green (550 nm) wavelengths that are substantially equal (e.g., ±10%) to one another. Unless otherwise noted herein, reflectance values are specular reflectance values. In terms of the CIELAB color space, materials having a neutral gray color can exhibit a* and b* values that are less than 5 in absolute value, assuming a 2° standard observer. Unless otherwise noted herein, CIELAB coordinate values are measured with a D65 light source. In embodiments, when exhibiting a neutral gray color, the material can exhibit a ratio of a* and b* values (a*/b*) that is less than or equal to 1. In any embodiment, as used herein, neutral may refer to substantial flatness over the spectral range from 400 nm to 700 nm, with a difference between a maximum reflectance value (rₘₐₓ) and a minimum reflectance value (rₘᵢₙ) less than or equal to 20%, 10%, 15%, 5%, 3%, or 1%.

Disclosed herein are materials and structures such as coatings and coated structures that have precisely controlled optical properties, including reflectivity, transmissivity, spectral shape, and color. Such coatings may be layered films deposited with physical vapor deposition (PVD). In some embodiments, the coated structures may have a neutral gray color. The coated structures described herein may exhibit a neutral gray color in reflection for light over a wide range of incidence angles (e.g., from 0° to 50°). In some embodiments, the coated structures may have precisely controlled reflectance and transmittance. The coatings disclosed herein are amenable to patterning and/or combination with digital printing to create patterns, logos, and/or images on transparent or semi-transparent substrates.

The coatings and coated structures are useful in any application in which a pattern, image, or logo on transparent or semi-transparent glass or plastic is desired. For example, the coatings and coated structures may be used in automobiles, personal electronic devices including mobile devices, and smart furniture. In automobiles, the coatings and coated structures may be part of interior displays (e.g., instrumental panels, dashboard displays, and infotainment displays), exterior windows, windshields, rear-view mirrors, side-view mirrors, and other surfaces. The coatings may form patterns or be combined with ink printing to create logos that distinguish one product or brand from another. The coatings may form patterns or be combined with ink printing to indicate the location of touch buttons or to indicate a status on automobile parts, personal electronic devices, and smart furniture, among other types of devices.

Conventional methods to create patterns, logos, and/or images on transparent or semi-transparent glass and/or plastic, such as offset lithography, flexography, digital printing (e.g., Inkjet printing), gravure, screen printing, spray deposition with masking tapes, and pressure printing, do not produce precise edges. Furthermore, it can be difficult to create precisely controlled reflectivity using conventional techniques. PVD coatings of dielectric materials and metals can be used to produce coatings with precise edging, but these conventional PVD coatings suffer from poor optical qualities. For example, the PVD coatings may appear to be different colors depending on the angle of incidence (AOI) of incident light. AOI-dependent color may be due to light interference in the PVD coating and may not be desired in applications where a uniform color is desired.

The PVD coatings disclosed herein may not have the same light interference and therefore may exhibit substantially little or no color change with different AOI light. In other words, the PVD coatings may provide improved optical performance, in terms of colorlessness or neutral color, and/or little to no color shift when viewed at varying viewing angles and/or wide viewing angles under an illuminant (e.g., from an illumination source). Exemplary illuminants include any one of CIE F2, CIE F10, CIE F11, CIE F12 and CIE D65. In any embodiment, the PVD coatings may exhibit an angular color shift (or angular color variation) in reflectance of about 5 or less, about 4 or less, about 3 or less, or about 2 or less between a reference viewing angle and any other viewing angle in the ranges provided herein (e.g., from about 100 to about 60° relative to a normal vector of the first major surface). As used herein, the phrase “color shift” or “color variation” (angular or reference point) refers to the change in both a* and b*, under the CIE L*, a*, b* colorimetry system in reflectance. It should be understood that unless otherwise noted, the L* coordinate of the PVD coatings described herein are the same at any angle or reference point and do not influence color shift. For example, angular color shift ΔE_{θ} may be determined using the following Equation (1):

$$Δ {E}_{θ} ( {a}^{*} , {b}^{*} ) = √ \{ {( {a}_{θ 1}^{*} - {a}_{θ 2}^{*} )}^{2} + {( {b}_{θ 1}^{*} - {b}_{θ 2}^{*} )}^{2} \} ,$$

where a*_{θ1} and b*_{θ1} are a* and b* coordinates of a point on the PVD coating when viewed at a first angle θ₁ or reference viewing angle (which may include normal incidence or any viewing angle in the ranges described herein), and a*_{θ2} and b*_{θ2} are a* and b* coordinates of the same point on the PVD coating when viewed at a second angle θ₂, where θ₁ and θ₂ are different (e.g., at least 5 degrees apart). For example, the angular color shift in reflectance of the PVD coating under an illuminant may be 10 or less (e.g., 5 or less, 4 or less, 3 or less, or 2 or less). For example, the angular color shift in reflectance may be about 4.1 or less, about 4.0 or less, about 3.9 or less, about 3.8 or less, about 3.7 or less, about 3.6 or less, about 3.5 or less, about 3.4 or less, about 3.3 or less, about 3.2 or less, about 3.1 or less, about 3.0 or less, about 2.9 or less, about 2.8 or less, about 2.7 or less, about 2.6 or less, about 2.5 or less, about 2.4 or less, about 2.3 or less, about 2.2 or less, about 2.1 or less, about 2.0 or less, about 1.9 or less, about 1.8 or less, about 1.7 or less, about 1.6 or less, about 1.5 or less, about 1.4 or less, about 1.3 or less, about 1.2 or less, about 1.1 or less, about 1 or less, about 0.9 or less, about 0.8 or less, about 0.7 or less, about 0.6 or less, about 0.5 or less, about 0.4 or less, about 0.3 or less, about 0.2 or less, or about 0.1 or less. In some implementations, the angular color shift may be about 0. The illuminant can include standard illuminants as determined by the CIE, including A illuminants (representing tungsten-filament lighting), B illuminants (daylight simulating illuminants), C illuminants (daylight simulating illuminants), D series illuminants (representing natural daylight), and F series illuminants (representing various types of fluorescent lighting). In specific examples, the PVD coatings exhibit an angular color shift in reflectance of about 4 or less, about 3 or less, about 2 or less, or about 1 or less when viewed at incident illumination angle from the reference illumination angle under a CIE F2, F10, F11, F12 or D65 illuminant, or more specifically, under a CIE D65 illuminant. In particular, the angular color shift is measured under a CIE D65 1964 illuminant. More specifically, in some examples of embodiments, the angular color shift in reflectance according to Equation (1) is about 5 or less when viewed at angles in a range from about 10° to about 60°, about 4 or less when viewed at angles in a range from about 10° to about 60°, about 3 or less when viewed at angles in a range from about 100 to about 60°, or about 2 or less when viewed at angles in a range from about 100 and about 60°, where the reference viewing angle can range from about 100 to about 600 and is different than the viewing angle upon which the color shift is based. For example, for a reference viewing angle of about 10°, the angular color shift can fall within the above series of ranges for viewing angles from about 100 to about 60°. Similarly, for reference viewing angles of about 15°, about 30°, about 45°, or about 60°, the angular color shift can fall within the above series of ranges for viewing angles from about 100 to about 60°. Examples are included below for viewing angles of 10°, 15°, 30°, 45°, and 60°, but the viewing angle is not limited to these specific examples and can include any angle in the range from about 10° to about 60°.

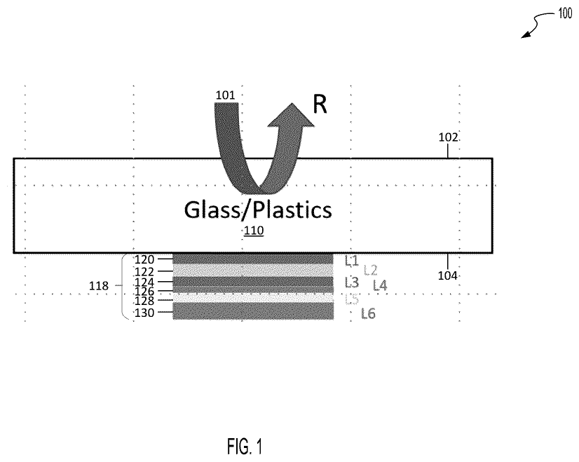

FIG. 1 is an illustration of a coated structure 100, in accordance with one or more embodiments. The coated structure 100 includes a substrate 110 and a layered film 118. The substrate includes a first surface 102 and a second surface 104 opposite to the first surface, and the layered film 118 is disposed on the second surface 104. In embodiments, the coated structure 100 is designed so that the first surface 102 faces the external environment when the coated structure 100 is incorporated into a functional apparatus (e.g., an automotive interior display or mobile consumer electronics device). Such a configuration is beneficial for touch screen applications because user contact with the layered film 118 is avoided.

In the depicted embodiment, the layered film 118 includes six coating layers: low-index layer 120, high-index layer 122, low-index layer 124, reflectivity-control layer 126, light absorbing layer 128, and light blocking layer 130 deposited on the second surface 104. When light 101 is incident on the first surface 102, the coated structure 100 can exhibit any suitable reflected color when viewed from the first surface 102. For example, in some embodiments, when light 101 is incident on the first surface 102 over a range of angles of incidence (e.g., from 0° to 60° or from 0° to 50°), the coated structure 100 may exhibit a neutral gray color (e.g., |a*|, |b*|≤5 and, optionally, a*/b*≤1; e.g., ≤0.8, 0.5, 0.4, 0.2, or 0.1) and a reflectivity of about 4% to about 98%. The total thickness of the multilayer coating of the coated structure 100 may be from about 100 nm to about 500 nm (e.g., 100 nm, 200 nm, 300 nm, 400 nm, or 500 nm), however, it will be appreciated that greater thicknesses are also possible and encompassed by the present disclosure (e.g., thicknesses within the range of 50 nm to 1 micrometer or greater).

The substrate 110 may be transparent or semi-transparent glass, plastic, or composite material. In embodiments where transparency is desired, the substrate 110 can exhibit an average transmittance that is greater than or equal to 85% for light from 400 nm to 700 nm when the substrate has a thickness that is greater than or equal to 0.4 mm and less than or equal to 2.0 mm. For example, the substrate 110 may be tempered glass (e.g., tempered automotive glass), laminated glass (e.g., two glass sheets joined using a polyvinyl butyral layer in between the sheets), an LCD glass substrate, a borosilicate glass, aluminosilicate glass, soda-lime glass, chemically strengthened borosilicate glass, chemically strengthened aluminosilicate glass, chemically strengthened soda-lime glass, thermoplastic polyurethane (TPU), polyester terephthalate (PET), acrylic, polycarbonate, or polyvinyl chloride (PVC), copolymers thereof, or a combination of two or more thereof. The substrate may have a thickness of from about 0.1 mm to about 10 cm. The uncoated substrate may have an average reflectance over a spectral range from 400 nm to 700 nm of about 3% to about 10% (e.g., 3%, 4%, 5%, 6%, 7%, 8%, 9%, or 10%).

The coating on the substrate 110 may include a color control stack. The color control stack utilizes interferometric suppression to control a reflected color of the coated structure 100 from the side of the first surface 102. The color control stack may include at least one layer having a refractive index (n) less than 1.7 and at least one layer having n greater than 1.7. Layers of low-index and high-index layers may alternate. Adjacent layers in the color control stack may have refractive indices that differ from one another by at least 0.05. In some implementations, the color control stack includes two low-index layers 120 and 124, and a high-index layer 122 sandwiched between the two low-index layers 120 and 124. The configuration of the color control stack may be selected to determine the spectral shape and the color of the coated structure 100.

The two low-index layers 120 and 124 each independently have a refractive index (n) less than or equal to 1.7 (e.g., 1.0, 1.1, 1.2, 1.3, 1.4, 1.5, 1.6, 1.7, or any value therebetween). The high-index layer 122 has a n greater than 1.7 (e.g., 1.8, 1.9, 2.0, 2.1, 2.2, 2.3, 2.4, 2.5, 2.6, 2.7, 2.8, 2.9, 3.0, or any value therebetween). Unless otherwise noted herein, refractive index values herein are given at 550 nm. As an example, the two low-index layers 120 and 124, each independently may be SiO₂, Al₂O₃, MgF₂, CaF₂, or a combination of two or more thereof. In some embodiments, both low-index layers are the same material. In other embodiments, the two low-index layers are different materials. As an example, the high-index layer 122 may be Nb₂O₅, TiO₂, ZrO₂, HfO₂, Ta₂O₅, ZnO, SnO₂, or a combination of two or more thereof.

In the depicted embodiment, the first low-index layer 120, which may be deposited directly on the substrate 110, has a thickness of about 10 nm to about 100 nm (e.g., about 15 nm to about 90 nm, or about 20 nm, 25 nm, 30 nm, 35 nm, 40 nm, 45 nm, 50 nm, 55 nm, 60 nm, 65 nm, 70 nm, 75 nm, 80 nm, 85 nm, or 90 nm). The second low-index layer 124 may have a thickness of about 20 nm to about 50 nm (e.g., about 20 nm, 25 nm, 30 nm, 35 nm, 40 nm, 45 nm, or 50 nm). The high-index layer 122 may have a thickness of about 5 nm to about 20 nm (e.g., about 5 nm, 10 nm, 15 nm, or 20 nm). In some embodiments, the coated structure 100 omits the high-index layer. Unless otherwise noted herein, the term “thickness” is used to describe a physical thickness of a layer or article, representing the minimum linear distance between two major surfaces of the article, taken in a direction perpendicular to one or more of the major surfaces. In embodiments where a neutral gray color is desired with a L* value that is less than or equal to 70.0, the first low-index layer 120 can comprise a thickness that is greater than or equal to 2 times the thickness of the low-index layer 124 (e.g., greater than or equal to 2 times and less than or equal to 4 times the thickness of the low-index layer 124). Without wishing to be bound by theory, it is believed that such a structure aids in providing a flat reflectance spectra from 400 nm to 700 nm at a variety of angles of incidence, as described in greater detail herein.

The coating includes a reflectivity-control layer 126. While only a single reflectivity-control layer 126 is shown, it should be understood that the layered film 118 can include more than one reflectivity-control layers (e.g., separated by a layer of low refractive index material such as SiO₂). The material and thickness of the reflectivity-control layer 126 may be selected to control the reflectivity of the coated structure 100, with a thicker reflectivity-control layer 126 increasing light reflectivity of the coated structure 100. The reflectivity-control layer 126 may provide the coated structure 100 with the neutral gray color by reflecting red, blue, and green light wavelengths substantially equally (i.e., ±10%).

For example, the reflectivity-control layer 126 may be chromium, aluminum, silver, nickel-based alloy, or a combination of two or more thereof. The nickel-based alloy may be, for example, an Inconel, which is a nickel-chromium-based superalloy. In some embodiments, the coated structure 100 has a chromium reflectivity-control layer 126 and a reflectivity of about 4% to about 55%. In some embodiments, the coated structure 100 has an aluminum reflectivity-control layer 126 and a reflectivity of about 4% to about 85%. In some embodiments, the coated structure 100 has a silver reflectivity-control layer 126 and a reflectivity of about 4% to about 98%. In embodiments, silver or aluminum reflectivity control layers 126 are used when a reflectivity of greater than 55% is desired. The reflectivity-control layer 126 may have a thickness of about 3 nm to about 50 nm (e.g., about 3 nm, 4 nm, 5 nm, 6 nm, 7 nm, 8 nm, 9 nm, 10 nm, 15 nm, 20 nm, 25 nm, 30 nm, 35 nm, 40 nm, 45 nm, or 50 nm).

The coating on the substrate 110 may include a light blocking stack. The light blocking stack may include light absorbing layer 128 and light blocking layer 130. The light absorbing layer 128 absorbs light in the visible spectrum. The light blocking layer 130 may have a high optical density (e.g., greater than 1, 2, 3, 4, or 5). The thickness and material of the light blocking layer 130 may be selected for a desired transmittance value of the coated structure 100, with thicker light blocking layers 130 providing lower transmittance.

For example, the light absorbing layer 128 may be CrOₓ, where x is 1 to 5, and the light blocking layer 130 may be chromium metal. In some embodiments, the light absorbing layer 128 and the light blocking layer 130 include the same metal to streamline deposition (e.g., by using the same sputtering target). The light absorbing layer 128 may have a thickness of about 10 nm to about 80 nm (e.g., 10 nm, 20 nm, 30 nm, 40 nm, 50 nm, 60 nm, 70 nm, or 80 nm). The light blocking layer 130 may have a thickness of at least about 120 nm (e.g., 120 nm to 150 nm, or 120 nm, 130 nm, 140 nm, or 150 nm).

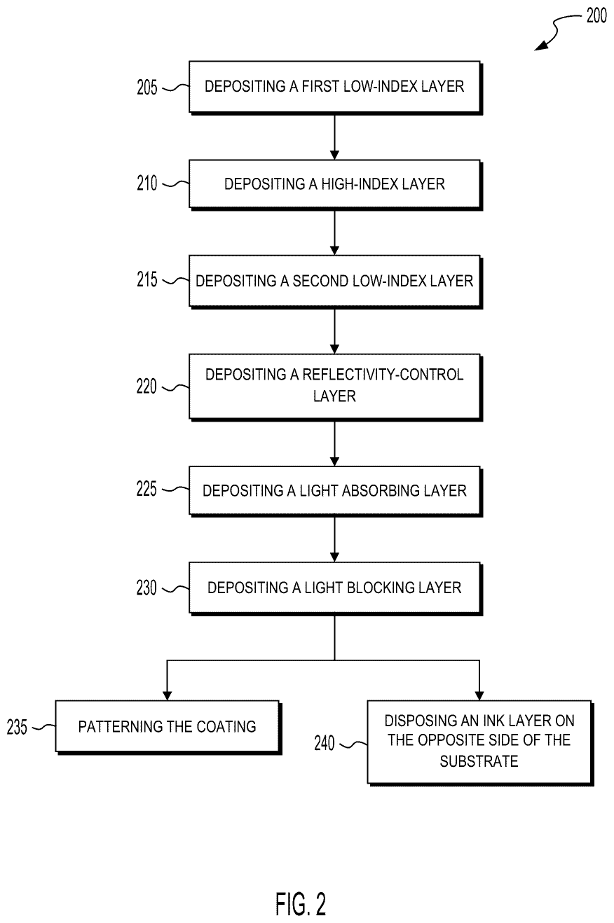

FIG. 2 is an example flow diagram 200 of a PVD process to prepare a coated structure, in accordance with one or more embodiments. The process 200 can be performed, for example, in one or more PVD process chambers. As shown, the process 200 can produce a coated structure having a multilayer coating deposited on a substrate, such as the coated structure 100 in FIG. 1. The substrate may be transparent or semi-transparent glass, plastic, or composite material.

The PVD process chambers may be configured for batch or in-line processing. The inline PVD coating system may allow enhanced throughput of the substrate. In some implementations, a single PVD process chamber is used to deposit the layers. In some implementations, multiple PVD process chambers are used to deposit the layers (e.g., each layer deposited by a different chamber). One or more types of PVD processing may be used, including electron beam deposition (“e-beam” or “EB”), ion-assisted deposition (IAD), ion-assisted deposition-EB (“IAD-EB”), cathodic arc deposition, thermal evaporation, sputtering, plasma enhanced chemical vapor deposition (PECVD) and other similar deposition techniques. In some embodiments, the PVD coating processes are “cold” processes where the substrate temperature is less than or equal to 100° C. In such processes, there may be no degradation of the substrate to which the coatings are applied (e.g., degradation of the strength of the chemically tempered glass substrate).

As an example, the PVD process for depositing the coating may include disposing one or more glass or plastic substrates in a PVD process chamber. At least one source material may be providing within the PVD process chamber for one or more coating layers. When more than one source material is provided, each source material is provided in a separate source material container. The process chamber may be evacuated to a pressure of about 10⁻⁴ Torr or less for the deposition of the coating. Following deposition of the coating, the coated substrate may be removed from the chamber to provide the coated substrate. In embodiments described herein, one or more layers of the coating may be deposited onto the substrate in a first chamber to form one or more layers of the coating, and one or more layers of the coating may be deposited in a second chamber to form one or more other layers of the coating. The chambers may be connected by a vacuum seal/isolation-lock for transferring the substrate with the optical coating formed thereon from the first chamber to the second chamber without exposing the substrate/coating to the atmosphere. In embodiments described herein one or more of the chambers may be divided into a number of coating sub-chambers. In some embodiments, the number of sub-chambers may be from 1-6. The sub-chambers may be used to deposit different materials.

At step 205, a first low-index layer is deposited on the substrate. The first low-index layer has a n less than or equal to 1.7. As an example, the first low-index layer may be SiO₂, Al₂O₃, MgF₂, CaF₂, or a combination of two or more thereof.

At step 210, a high-index layer is deposited on the first low-index layer. The high-index layer has a n greater than 1.7. As an example, the high-index layer may be Nb₂O₅, TiO₂, ZrO₂, HfO₂, Ta₂O₅, ZnO, SnO₂, or a combination of two or more thereof.

At step 215, a second low-index layer is deposited on the high-index layer. The second low-index layer has a n less than or equal to 1.7. As an example, the second low-index layer may be SiO₂, Al₂O₃, MgF₂, CaF₂, or a combination of two or more thereof.

At step 220, a reflectivity-control layer is deposited on the second low-index layer. The material and thickness of the reflectivity-control layer may be selected to control the reflectivity of the coated structure. The reflectivity-control layer may be chromium, aluminum, silver, Inconel, or a combination of two or more thereof. The reflectivity-control layer may have a thickness of about 3 nm to about 50 nm.

At step 225, a light absorbing layer is deposited on the reflectivity-control layer. The light absorbing layer absorbs light in the visible spectrum. For example, the light absorbing layer may be CrOₓ, where x is 1 to 5.

At step 230, a light blocking layer is deposited on the light absorbing layer. The thickness and material of the light blocking layer may be selected for a desired transmittance value of the coated structure, with thicker light blocking layers 130 providing lower transmittance. For example, the light blocking layer can have a high optical density (e.g., greater than 1, 2, 3, 4, or 5). For example, the light blocking layer may be Cr.

Once the coating is formed in steps 205-230, the coating may be patterned at step 235. The coating may be patterned using one or more semiconductor etching processes. For example, the coating may be patterned via reaction ion etching (RIE) using one or more reactive gas (e.g., Cl₂, F, Ar, or O₂) plasma in a vacuum chamber. With RIE, the coating is masked in a desired pattern by photoresist, the regions outside of the desired pattern are removed via RIE, and the photoresist is removed after the etching. As another example, the coating may be patterned via wet etching using a chemical. With wet etching, the coating is masked in a desired pattern by photoresist, the regions outside of the desired pattern are removed via wet etching, and the photoresist is removed after the etching. As another example, the coating may be patterned via lift-off, where the substrate is patterned with the photoresist, then the coating is deposited on top of the substrate and the patterned photoresist, and then the photoresist is removed via ultrasonic stripping in chemical agents (e.g., acetone), which also removes the coating that was deposited on the photoresist.

Additionally or alternatively to patterning, the coating can be combined with digital printing at step 240. Digital printing may include depositing a thin or thick ink layer on the coating, a region of the PVD coating-side of the substrate that is not coated, and/or on the opposite side of the substrate from the PVD coating to block light in the desired pattern or image. For example, inkjet printing may be used to print a predetermined design on the PVD coating. The inkjet printing results in an ink coating on the PVD coating. For example, inkjet printing may be used to print a predetermined design on the second surface of a substrate. The inkjet printing results in an ink coating on the second surface of the substrate. In any example, the ink coating may be cured and then, optionally, cleaned to remove uncured ink. Multiple inkjet printing ink coatings may be applied to one or more surfaces of the substrate (e.g., to form different colored coatings). The inks used in the inkjet printing can be thermally-curable inks or UV-curable inks. In some embodiments, the inks can be resin-based inks that are thermally-curable and/or UV-curable. Thermally-curable inks are cured by baking at elevated temperatures (e.g., between 80° C. and 180° C.). UV-curable inks are cured by UV light.

The ink-coated structure may be illuminated with a light source. When illuminated, light may be substantially blocked from being transmitting through the ink-coated structure by the ink coating, so that the outline of the image is primarily illuminated. The inks may be selected to match a color of the portion of the substrate 110 covered by the layered film 118. For example, in embodiments, regions of the substrate 110 covered by the printed ink layer may exhibit a reflected color from the light 101 that is substantially the same as that of the region covered by the layered film 118 (e.g., the regions can exhibit a maximum AE value that is less than or equal to 5.0, 4.0, 3.0, 2.0, or even 1.0).

### EXAMPLES

Embodiments of the present disclosure may be further understood in view of the following examples.

Seven coatings were deposited on glass substrates via PVD to test their optical properties. These example coating were made in accordance with the coated structure depicted in FIG. 1. A first low-index layer (L1) of SiO₂ was deposited on the glass substrate having a thickness of about 1 mm. A high-index layer (L2) of Nb₂O₅ was deposited on the first low-index layer. A second low-index layer (L3) of SiO₂ was deposited on the Nb₂O₅. A reflectivity-control layer (L4) of Cr was deposited on the second low-index layer. A light absorbing layer (L5) of CrOₓ, where x is 1 to 5, was deposited on the Cr layer. A light blocking layer (L6) of Cr was deposited on the CrOₓ layer. The thickness of the layers are listed in Table 1.

TABLE 1
Example Coating Layer Thicknesses (nm) on Glass.

| | | Layer Thickness | | | | | | |
|---|---|---|---|---|---|---|---|---|
| Layer | Material | L*80 | L*70 | L*60 | L*50 | L*45 | L*40 | L*30 |
| L1 | SiO₂ | 18.99 | 61.8 | 80.65 | 83.91 | 73.08 | 81.66 | 86.54 |
| L2 | Nb₂O₅ | 0 | 12.63 | 14.03 | 13.06 | 12.87 | 10.13 | 13.27 |
| L3 | SiO₂ | 40.63 | 32.29 | 31.04 | 33.3 | 33.58 | 34.87 | 23.47 |
| L4 | Cr | 37.11 | 26.82 | 15.04 | 9.87 | 8.12 | 6.28 | 4.28 |
| L5 | CrOₓ | 72.85 | 16.22 | 35.11 | 34.34 | 41.69 | 42.41 | 43.74 |
| L6 | Cr | 120 | 120 | 120 | 120 | 120 | 120 | 120 |

| | | | | | | | |
|---|---|---|---|---|---|---|---|
| Total Thickness | 249.58 | 229.76 | 255.87 | 254.48 | 249.34 | 255.34 | 251.29 |

For each example coating in Table 1, a different thickness of the reflectivity-control layer (L4) was selected, and the thickness of layers L1, L2, L3, and L5 were adjusted to balance the flatness of the reflective spectra. The thickness of the light blocking layer (L6) was set at 120 nm to provide an optical density (OD=log(1/T)) of greater than 4.

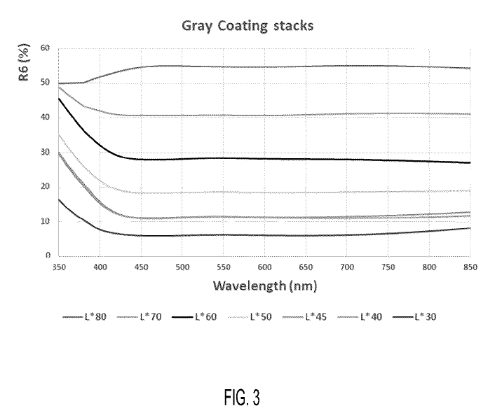

FIG. 3 is a graph of the reflectivity spectra of example coating in Table 1. The measured spectra was 350 nm to 850 nm. Reflectivity was measured using a CIE standard illuminant D65. Results indicated that the coating with thicker L4 layers had higher reflectivity across the spectrum. L*80 (with L4=37.11 nm) had a higher reflectivity of 50% to 60%. L*30 (with L4=4.28) had a lower reflectivity of about 5% to 15%. The reflectance spectra of each of the examples were flat over the spectral range from 400 nm to 700 nm. Particularly, for each of the examples, from 400 nm to 700 nm, a difference between a maximum reflectance value (rₘₐₓ) and a minimum reflectance value (rₘᵢₙ) was less than or equal to 5%. The reflectance spectra are particularly flat over the spectral range from 450 nm to 700 nm. Indeed, each of the examples exhibited rₘₐₓ-rₘᵢₙ that is less than or equal to 1.0% over the spectral range from 450 nm to 700 nm.

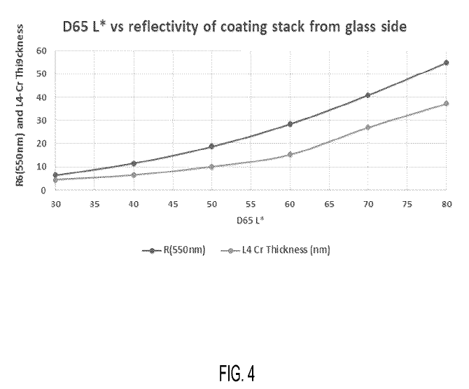

FIG. 4 is another graph of the reflectivity of example coatings. FIG. 4 illustrates the relationship between D65 L* and spectra reflectivity at 550 nm, and the relationship between D65 L* and the thickness of the reflectivity-control layer (L4). The thickness of the layer is in nm and the reflectivity-control layer was Cr in this example.

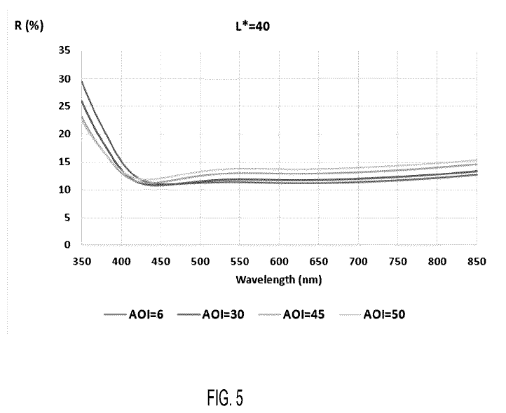

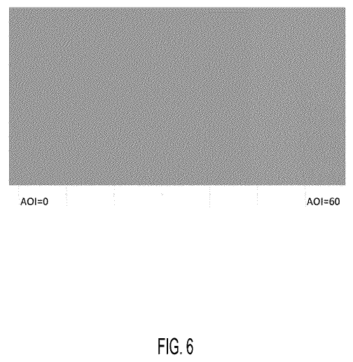

FIG. 5 is a graph of reflectivity of example coating L*40 (with L4=6.28 nm) illuminated at different angles of incidence (AOI) using the D65 L*. The measured spectra was 350 nm to 850 nm and the AOI values were 6°, 30°, 45°, and 60°. For all of the measured AOI, there was little difference (i.e., <10%) in reflectivity values across the spectra from 400 nm to 700 nm. The results in FIG. 6 are corroborated by CIELAB color space values for L*, a*, and b* at different AOI in Table 2. Notably, at each wavelength from 400 nm to 700 nm, the percentage reflectance does not change by more than 5% when the angle of incidence is increased from 6° to 50°. Such consistency in reflection spectra shape indicates a consistent appearance in reflectance irrespective of illumination and viewing angle.

TABLE 2
Spectral properties of L*40 (with L4 = 6.28 nm) at different AOI.

| Incident Angle (°) | L* | a* | b* |
|---|---|---|---|
| 0 | 45.1 | −0.0177 | −0.025 |
| 10 | 45.1 | −0.0884 | 0.234 |
| 20 | 45.3 | −0.2891 | 0.9464 |
| 30 | 45.7 | −0.5841 | 1.9269 |
| 40 | 46.5 | −0.9105 | 2.8914 |
| 50 | 48.0 | −1.1747 | 3.4874 |
| 60 | 51.2 | −1.248 | 3.3445 |

FIG. 6 is an illustration of the angular color shift across the spectra of example coating L*40 with changing AOL. As shown in FIG. 6, little color change is observed as the AOI changes from AOI=0 to AOI=60.

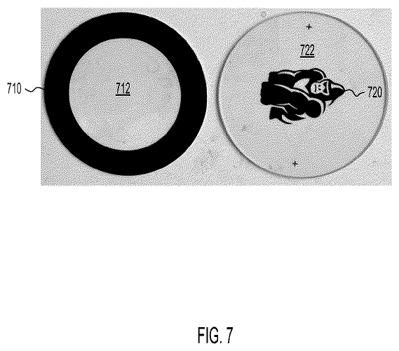

As another example, FIG. 7 is a photograph of two example coatings on glass. The glass substrates 712 and 722 have an outer diameter of 58.2 mm. A first example coating 710 is a patterned coating in the shape of a ring along the outer edge of the glass 712. A second example coating 720 is an example logo centered in the middle of the glass 722. The coatings are multilayer coatings deposited via PVD.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the Figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems, apparatuses, and methods shown in the various exemplary embodiments is illustrative only. Additionally, any element disclosed in one embodiment may be incorporated or utilized with any other embodiment disclosed herein. For example, any of the exemplary embodiments described in this application can be incorporated with any of the other exemplary embodiment described in the application. Although only one example of an element from one embodiment that can be incorporated or utilized in another embodiment has been described above, it should be appreciated that other elements of the various embodiments may be incorporated or utilized with any of the other embodiments disclosed herein.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A structure comprising:
a substrate formed of glass, plastic, or a combination thereof, the substrate comprising a first surface and a second surface opposite the first surface;
a layered film disposed on the first surface of the substrate, the layered film comprising a reflectivity-control layer including chromium, aluminum, silver, or Inconel;
wherein, when viewed from the second surface, a region of the structure including the layered film exhibits a neutral gray color and a reflectivity of about 4% to about 98% when light is initially incident on the second surface and reflects off of the layered film; and
wherein the layered film is patterned such that a peripheral shape of the layered film defining the region differs from a peripheral shape of the substrate.

2. The structure of claim 1, wherein the layered film exhibits a*/b* less than 1.

3. The structure of claim 1, wherein for each wavelength in a wavelength range of 400 nm to 700 nm, a reflectance of the layered film increases by no more than 5% when an angle of incidence of the light on the layered film increases from 6° to 50°.

4. The structure of claim 1, wherein the reflectivity-control layer includes chromium and has a thickness of about 3 nm to about 50 nm.

5. The structure of claim 1, wherein the layered film further comprises a color control stack, the color control stack comprising alternating layers of layers having a n less than 1.7 and layers having n greater than 1.7.

6. The structure of claim 5, wherein the color control stack includes two low-index layers having a refractive index (n) less than 1.7 and a high-index layer between the two low-index layers having n greater than 1.7.

7. The structure of claim 6, wherein the two low-index layers comprise SiO₂, Al₂O₃, or a combination thereof, wherein the high-index layer comprises Nb₂O₅, TiO₂, ZrO₂, HfO₂, Ta₂O₅, ZnO, SnO₂, or a combination of two or more thereof.

8. The structure of claim 1, wherein the layered film further comprises a light blocking stack including a light absorbing layer and a light blocking layer, the light blocking layer providing an optical density greater than 4.

9. The structure of claim 8, wherein the light absorbing layer is CrOₓ, wherein x is in a range of 1 to 5, and wherein the light blocking layer is chromium metal having a thickness of at least 120 nm.

10. The structure of claim 1, wherein a thickness of the layered film is about 100 nm to about 300 nm.

11. The structure of claim 1, wherein the peripheral shape of the layered film comprises a pattern, a logo, or an image.

12. The structure of claim 1, further comprising:
an ink layer disposed on the second surface of the substrate or on a portion of the layered film; and
an illumination source providing light directed toward the second surface,
wherein the ink layer exhibits a reflected color from the illumination source with a AE value that is less than or equal to 5.0 as compared to the region of the structure including the layered film.

13. A method of manufacturing a structure, the method comprising:
depositing a layered film on a first surface of a substrate via physical vapor deposition (PVD); and
patterning the layered film such that a peripheral shape of the layered film defining a region including the layered film is different from a peripheral shape of the substrate;
wherein, when viewed from a second surface of the substrate opposite the first surface, the region including the layered film exhibits a neutral gray color and a reflectivity of about 4% to about 98% when light is initially incident on the second surface and reflects off of the layered film.

14. The method of claim 13, wherein depositing the layered film comprises depositing a reflectivity-control layer including chromium, aluminum, silver, or Inconel on the first surface.

15. The method of claim 14, wherein depositing the layered film comprises depositing a light absorbing layer on the reflectivity-control layer, wherein depositing the layered film comprises depositing a light blocking layer on the light absorbing layer, the light blocking layer providing an optical density greater than 4.

16. The method of claim 15, wherein the light blocking layer is chromium metal, wherein the light blocking layer has a thickness of at least 120 nm.

17. The method of claim 13, wherein depositing the layered film further comprises:
depositing a first low-index layer having a refractive index (n) less than 1.7 onto the first surface;
depositing a high-index layer having n greater than 1.7 onto the first low-index layer; and
depositing a second low-index layer having a refractive index (n) less than 1.7 onto the high-index layer, wherein the first low-index layer and the second low-index layer each comprise SiO₂, Al₂O₃, or a combination thereof, wherein the high-index layer comprises Nb₂O₅, TiO₂, ZrO₂, HfO₂, Ta₂O₅, ZnO, SnO₂, or a combination of two or more thereof.

18. The method of claim 13, wherein the peripheral shape of the layered film comprises a pattern, a logo, or an image.

19. The method of claim 13, wherein a thickness of the layered film is about 100 nm to about 300 nm.

20. A layered film comprising:
a first layer comprising SiO₂ having a thickness of about 15 nm to about 90 nm;
a second layer disposed on the first layer, the second layer comprising Nb₂O₅ having a thickness of about 5 nm to about 20 nm;
a third layer disposed on the second layer, the third layer comprising SiO₂ having a thickness of about 20 nm to about 50 nm;
a fourth layer disposed on the third layer, the fourth layer comprising chromium metal having a thickness of about 3 nm to about 50 nm;
a fifth layer disposed on the fourth layer, the fifth layer comprising CrOₓ, wherein x is in a range of 1 to 5, the fifth layer having a thickness of about 10 nm to about 80 nm; and
a sixth layer disposed on the fifth layer, the sixth layer comprising chromium metal having a thickness of about 110 nm to about 130 nm.
